(19) United States
(12) Patent Application Publication
(10) Pub. No.: US 2011/0231521 A1
(43) Pub. Date: Sep. 22, 2011

(54) MEDIA CONVERGENCE PLATFORM

(75) Inventors: Tricia Higgins, Sausalito, CA (US); Kay Johansson, Alamo, CA (US); Kent Karlsson, Berkeley, CA (US); Anders Odlund, San Francisco, CA (US); Linus Larsen, Stockholm (SE); Petter Berglund, Strangnas (SE); Fritz Barnes, Emeryville, CA (US)

(73) Assignee: MOBITV, INC., Emeryville, CA (US)

(21) Appl. No.: 13/053,103

(22) Filed: Mar. 21, 2011

Related U.S. Application Data
(60) Provisional application No. 61/316,345, filed on Mar. 22, 2010.

(51) Int. Cl. G06F 15/16

(52) U.S. Cl. 709/219

(57) ABSTRACT

A media convergence platform allows time-shifting and place-shifting of live, video on demand, and recorded content across multiple devices, displays, etc. Users are able to pause content on one device and resume where they left off on another device. The media convergence platform allows users to record, select, consume, add, delete, manage, and manipulate media content including live programming across user authorized devices such as set top boxes, computer systems, mobile devices, etc.

### CROSS-REFERENCE TO RELATED APPLICATION

This application claims the benefit of priority under 35 U.S.C. §119(e) to U.S. Provisional Application No. 61/316,345 (MOBIP049P), titled “MEDIA CONVERGENCE PLATFORM,” filed Mar. 22, 2010, all of which is incorporated in its entirety by this reference.

### TECHNICAL FIELD

The present disclosure relates to a media convergence platform.

### DESCRIPTION OF RELATED ART

A variety of devices such as computers systems, set top boxes, and mobile devices can be configured to provide media to consumers. In some instances, consumers can stream live video content to a desktop, watch a satellite feed on a set-top box, or download a video on demand clip on a mobile device. Each device provides its own benefits and viewing and listening experience. However, mechanisms for managing media across devices are limited.

Conventional techniques and mechanisms allow media content display on multiple devices. However, mechanisms for efficiently selecting, managing, and experiencing media across multiple platforms are limited. Consequently, it is desirable to provide an efficient and effective media convergence platform.

### BRIEF DESCRIPTION OF THE DRAWINGS

The disclosure may best be understood by reference to the following description taken in conjunction with the accompanying drawings, which illustrate particular embodiments.

FIG. 1 illustrates a particular example of a network that can use the techniques and mechanisms of the present invention.

FIG. 2 illustrates a particular example of a content delivery system.

FIG. 3 illustrates one example of a convergence mechanism.

FIG. 4 illustrates one example of content server having channel buffers.

FIG. 5 illustrates one example of a media stream management table.

FIG. 6 illustrates example of entry points in a media stream.

FIG. 7 illustrates one example of a technique for resuming media transmissions.

FIG. 8 illustrates one example of a system for processing media streams.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices. However, it should be noted that a variety of devices can be use. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

A media convergence platform allows time-shifting and place-shifting of live, video on demand, and recorded content across multiple devices, displays, etc. Users are able to pause content on one device and resume where they left off on another device. The media convergence platform allows users to record, select, consume, add, delete, manage, and manipulate media content including live programming across user authorized devices such as set top boxes, computer systems, mobile devices, etc.

### Example Embodiments

Limited mechanisms are available for delivering content to devices such as set top boxes, computer systems, and mobile devices. In many instances, the services delivering content to the devices are disparate and lack coordination. A user may have rights to view content on one device but not another. Similarly, different versions of content suitable for viewing on different types of devices may not be available. A user typically has to manually determine a point in which to resume viewing.

A variety of mechanisms are used to deliver media streams to devices. In particular examples, a client establishes a session such as a Real-Time Streaming Protocol (RTSP) session. A server computer receives a connection for a media stream, establishes a session, and provides a media stream to a client device. The media stream includes packets encapsulating frames such as Moving Pictures Expert Group (MPEG) frames. The MPEG frames themselves may be key frames or differential frames. The specific encapsulation methodology used by the server depends on the type of content, the format of that content, the format of the payload, the application and transmission protocols being used to send the data. After the client device receives the media stream, the client device decapsulates the packets to obtain the MPEG frames and decodes the MPEG frames to obtain the actual media data.

In many instances, a server computer obtains media data from a variety of sources, such as media libraries, cable providers, satellite providers, and processes the media data into MPEG frames such as MPEG-2 or MPEG-4 frames. In particular examples, a server computer may encode six media streams of varying bit rates for a particular channel for distribution to a variety of disparate devices.

According to various embodiments, a user on a device such as a mobile device obtains a media stream by establishing an RTSP session. However, clients deployed on various devices have differing capabilities. Some examples of client capability characteristics include screen size, video and audio codec support, sound capabilities, bandwidth limitations, memory limitations, etc. In many implementations, content servers have to present users with multiple different streams that are tailored for different devices. In many instances, only selected streams work for particular clients and devices and a user often is burdened with the task of selecting the appropriate stream.

In some embodiments, a client feature allows a content server to present the client with a list of streams, but this requires extra intelligence in a client. Many clients do not support this feature. Consequently, the techniques and mechanisms of the present invention allow a content server to intelligent identify client capabilities and intelligent select a stream to provide to the client. According to various embodiments, an optimal stream is selected and the client does not require any intelligence or user input. In some examples, a user-agent and or other headers in the RTSP protocol are used to map a client against an entry in a database that allows the server to present the user with only compatible streams and prioritize them based on quality so that the default choice is the best for that client. In some embodiments, the default choice is automatically selected.

Mechanisms for managing programming across multiple devices and operating systems are limited. Consequently, the techniques of the present invention provide a platform for allowing efficient user selection, viewing, and management of media content across multiple devices having disparate capabilities. Both live and video on demand content once authorized on one device is made available to all registered devices. Recordings are accessible on all devices whether the actual physical recording is made on a user device, multiple user devices, or on a content provider or service provider server. Deleting recorded content will delete the content across all convergent devices. Other operations such as scheduled recordings can be synchronized upon execution on one device.

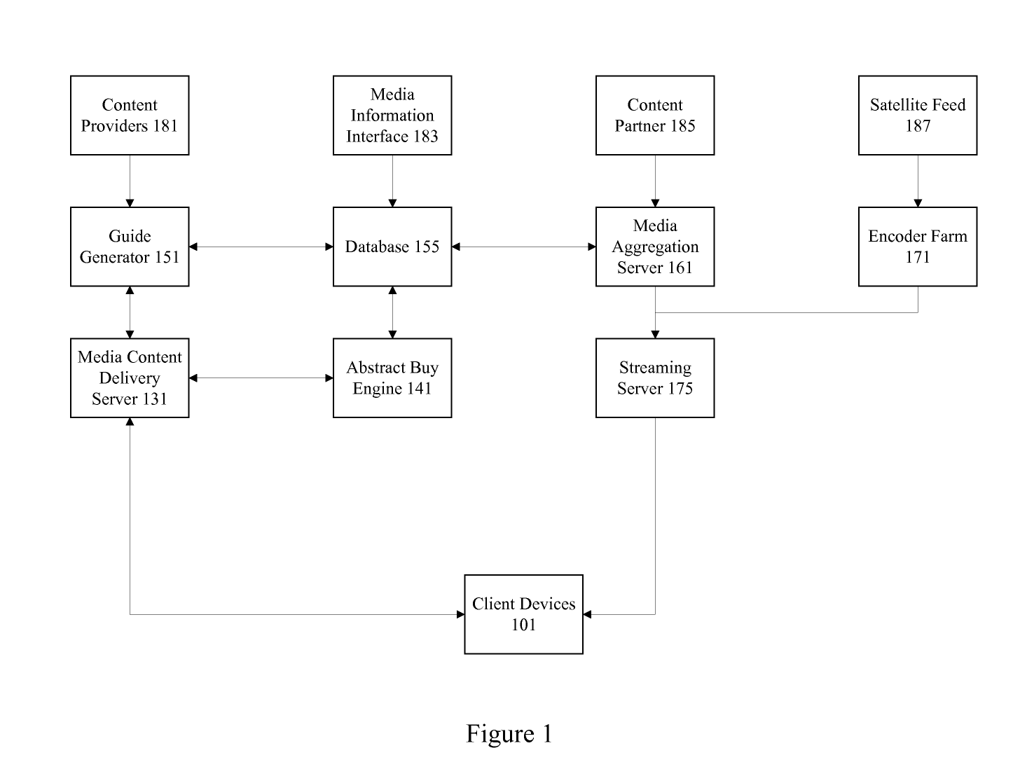

FIG. 1 is a diagrammatic representation showing one example of a network that can use the techniques of the present invention. According to various embodiments, media content is provided from a number of different sources 185. Media content may be provided from film libraries, cable companies, movie and television studios, commercial and business users, etc. and maintained at a media aggregation server 161. Any mechanism for obtaining media content from a large number of sources in order to provide the media content to mobile devices in live broadcast streams is referred to herein as a media content aggregation server. The media content aggregation server 161 may be clusters of servers located in different data centers. According to various embodiments, content provided to a media aggregation server 161 is provided in a variety of different encoding formats with numerous video and audio codecs. Media content may also be provided via satellite feed 157.

An encoder farm 171 is associated with the satellite feed 187 and can also be associated with media aggregation server 161. The encoder farm 171 can be used to process media content from satellite feed 187 as well as possibly from media aggregation server 161 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi-Narrow Band (AMR-NB), Advanced Audio coding (AAC), and AACPlus. The media content may also be encoded to support a variety of data rates. The media content from media aggregation server 161 and encoder farm 171 is provided as live media to a streaming server 175. In one example, the streaming server is a Real Time Streaming Protocol (RTSP) server 175. Media streams are broadcast live from an RTSP server 175 to individual client devices 101. A variety of protocols can be used to send data to client devices.

Possible client devices 101 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 131. The media content delivery server 131 is configured to allow a client device 101 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 151. The guide generator 151 obtains information from disparate sources including content providers 181 and media information sources 183. The guide generator 151 provides program guides to database 155 as well as to media content delivery server 131 to provide to client devices 101.

According to various embodiments, the guide generator 151 obtains viewership information from individual client devices. In particular embodiments, the guide generation 151 compiles viewership information in real-time in order to generate a most-watched program guide listing most popular programs first and least popular programs last. The client device 101 can request program guide information and the most-watched program guide can be provided to the client device 101 to allow efficient selection of video content. According to various embodiments, guide generator 151 is connected to a media content delivery server 131 that is also associated with an abstract buy engine 141. The abstract buy engine 141 maintains subscription information associated with various client devices 101. For example, the abstract buy engine 141 tracks purchases of premium packages.

The media content delivery server 131 and the client devices 101 communicate using requests and responses. For example, the client device 101 can send a request to media content delivery server 131 for a subscription to premium content. According to various embodiments, the abstract buy engine 141 tracks the subscription request and the media content delivery server 131 provides a key to the client 101 to allow it to decode live streamed media content. Similarly, the client device 101 can send a request to a media content delivery server 131 for a most-watched program guide for its particular program package. The media content delivery server 131 obtains the guide data from the guide generator 151 and associated database 155 and provides appropriate guide information to the client device 101.

Although the various devices such as the guide generator 151, database 155, media aggregation server 161, etc. are shown as separate entities, it should be appreciated that various devices may be incorporated onto a single server. Alternatively, each device may be embodied in multiple servers or clusters of servers. According to various embodiments, the guide generator 151, database 155, media aggregation server 161, encoder farm 171, media content delivery server 131, abstract buy engine 141, and streaming server 175 are included in an entity referred to herein as a media content delivery system.

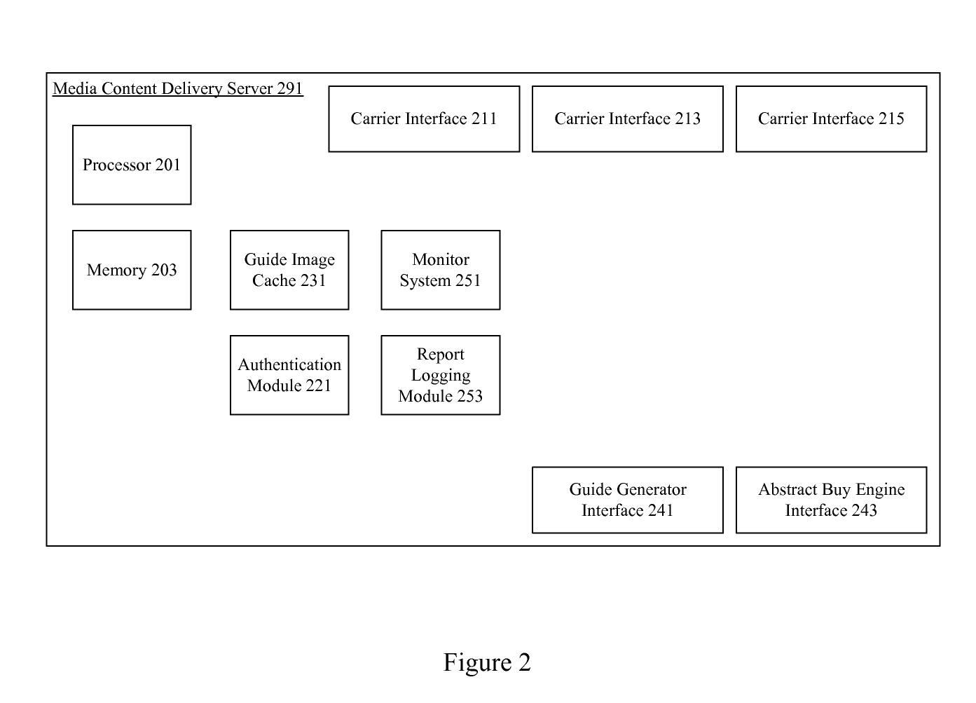

FIG. 2 is a diagrammatic representation showing one example of a media content delivery server 291. According to various embodiments, the media content delivery server 291 includes a processor 201, memory 203, and a number of interfaces. In some examples, the interfaces include a guide generator interface 241 allowing the media content delivery server 291 to obtain program guide information. The media content delivery server 291 also can include a program guide cache 231 configured to store program guide information and data associated with various channels. The media content delivery server 291 can also maintain static information such as icons and menu pages. The interfaces also include a carrier interface 211 allowing operation with mobile devices such as cellular phones operating in a particular cellular network. The carrier interface allows a carrier vending system to update subscriptions. Carrier interfaces 213 and 215 allow operation with mobile devices operating in other wireless networks. An abstract buy engine interface 243 provides communication with an abstract buy engine that maintains subscription information.

An authentication module 221 verifies the identity of mobile devices. A logging and report generation module 253 tracks mobile device requests and associated responses. A monitor system 251 allows an administrator to view usage patterns and system availability. According to various embodiments, the media content delivery server 291 handles requests and responses for media content related transactions while a separate streaming server provides the actual media streams. In some instances, a media content delivery server 291 may also have access to a streaming server or operate as a proxy for a streaming server. But in other instances, a media content delivery server 291 does not need to have any interface to a streaming server. In typical instances, however, the media content delivery server 291 also provides some media streams. The media content delivery server 291 can also be configured to provide media clips and files to a user in a manner that supplements a streaming server.

Although a particular media content delivery server 291 is described, it should be recognized that a variety of alternative configurations are possible. For example, some modules such as a report and logging module 253 and a monitor 251 may not be needed on every server. Alternatively, the modules may be implemented on another device connected to the server. In another example, the server 291 may not include an interface to an abstract buy engine and may in fact include the abstract buy engine itself. A variety of configurations are possible.

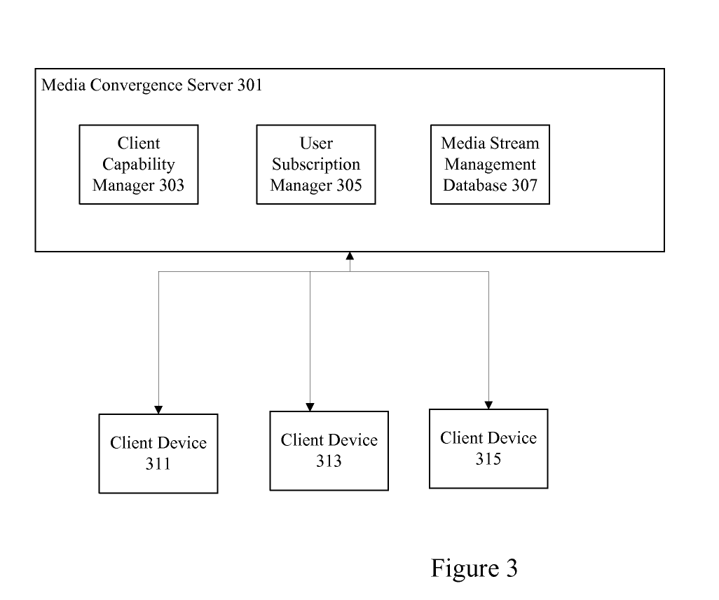

FIG. 3 illustrates one example of a media convergence platform. According to various embodiments, a media convergence server or content server 301 includes a client capability manager 303, a user subscription manager 305, and a media stream management database 307. According to various embodiments, the client capability manager 303 identifies individual client devices 311, 313, and 315, and determines client capabilities. In particular embodiments, the client capability manager 303 identifies what type of media stream should be sent to particular devices. In some examples, the client capabilities manager 303 identifies the type of encoding, the resolution, the sound quality, etc., that should be provided to particular client devices. According to various embodiments, a user subscription manager 305 identifies users, user preferences, characteristics, devices associated with the user, subscription levels, access levels, digital rights, etc. The same digital rights can apply across devices to a particular user. In particular embodiments, if a user has a premium movies subscription for a mobile device, the rights associated with the premium movies subscription apply to the mobile device, a set top box, and a laptop owned by the user.

According to various embodiments, the user has the option to view the live content. The user can also set up a reminder, or create an individual recording or series recording, all of which will also be saved on the other convergent client applications. According to various embodiments, the user has the option to view the recorded content or to delete the recorded content. If the user deletes the recorded content, it will get deleted from the list of recordings across all convergent devices. Scheduled recordings work in the same manner in that once a recording is deleted, it will be deleted across all convergent devices.

According to various embodiments, the media stream management database 307 identifies media streams viewed by a user on any device and provides an option to resume viewing upon switching to another device. Position information is stored to allow seamless migration to another device. In some examples, a live show is recorded from where a viewer stops viewing until the viewer resume viewing on another device. The viewer has the option of continuing to experience programs including live programs as though there were no disruptions. The live stream may be recorded on one or more user devices or may be maintained at a content server.

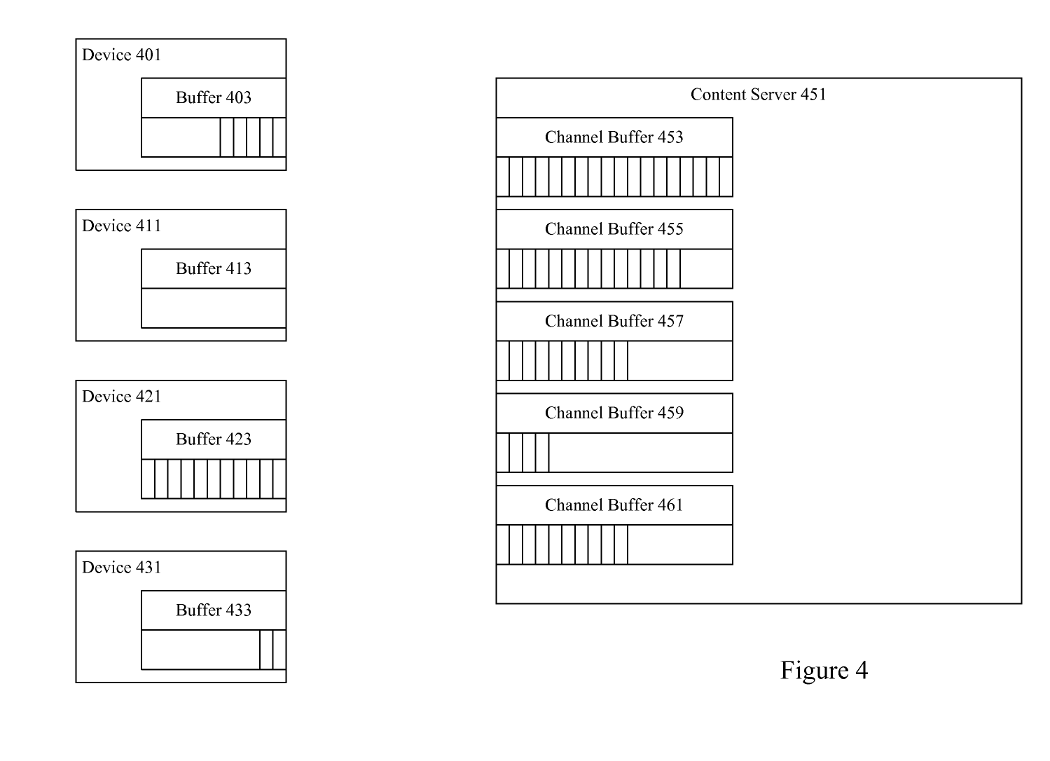

FIG. 4 illustrates one example of content server buffers. According to various embodiments, devices 401, 411, 421, and 431 have individual buffers 403, 413, 423, and 433. Content server 451 includes channel buffers 453, 455, 457, 459, and 461. In particular embodiments, a content server 451 detects that a device has little or no data remaining in a buffer. A device such as a mobile device may have little or no data in a buffer when network conditions cause transmission delays and drop packets or when a device initially requests a media stream. To improve user experience, a content server 451 bursts available data for a requested stream to a device 411 having a low or empty buffer. In some examples, the content server 451 transmits data from channel buffer 455 to device 411 at double the usual transmission bit rate for a fixed number of seconds.

In other examples, the content server 451 transmits data from a low quality stream in channel buffer 453 to device 411. Transmitting a lower quality stream allows a buffer to be filled while maintaining the same transmission bit rate. For example, a stream in channel buffer 453 may be a 50 mbps stream while a stream in channel buffer 455 may be a 100 mbps stream. More frames from the lower quality stream can be transmitted to allow the device 411 to resume playback with decreased delay.

According to various embodiments, content server buffers may or may not be prefilled. In some examples, once a media stream has been requested, the corresponding channel buffer is filled at the content server. However, channel buffers corresponding to media streams not yet requested are typically not prefilled or prewarmed. Playback can be delayed while the content server channel buffers are filled. Consequently, the techniques and mechanisms of the present invention contemplate prefilling channel buffers. According to various embodiments, the content server channel buffers are prefilled using live streams from cable and satellite providers and continually refreshed with the most recent streaming data. In some instances, all channel buffers are prefilled. In other instances, selected channel buffers are prefilled and refreshed using satellite and cable media streams.

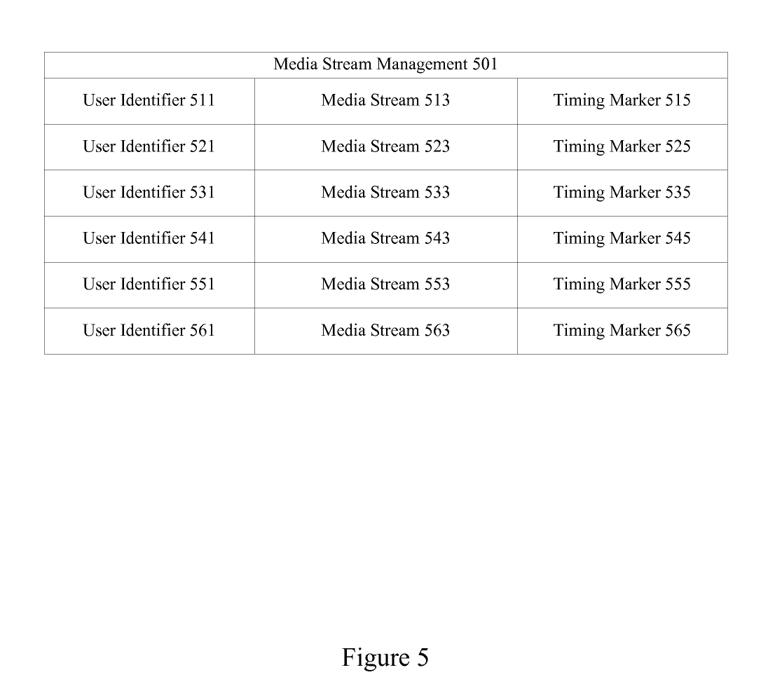

FIG. 5 illustrates one example of a mechanism for maintaining timing information. According to various embodiments, a content server maintains information about the program a user last watched and when the user stopped watching the program. In particular embodiments, a media stream management database 501 holds user identifiers 511, 521, 531, 541, 551, and 561. The user identifiers may correspond to specific subscribers, individuals, or devices. In particular embodiments, the media stream management database 501 also holds information about the media stream being viewed by a particular user. The media stream fields 513, 523, 533, 543, 553, and 563 identify particular channels or particular media streams that a user stopped viewing. Timing markers 515, 525, 535, 545, 555, and 565 identify points in time where viewing stopped. In some instances, the timing markers correspond to time information included in RTP packets.

According to various embodiments, a content server detects a stoppage event, such as a session close message, a session break message, or other disruption in the transmission of the stream to a device, and marks the time when the viewing stopped. In some examples, the stoppage point is recorded as being a few seconds before an actual stoppage event is detected, to allow some possible overlap when a user resumes viewing or listening to a stream.

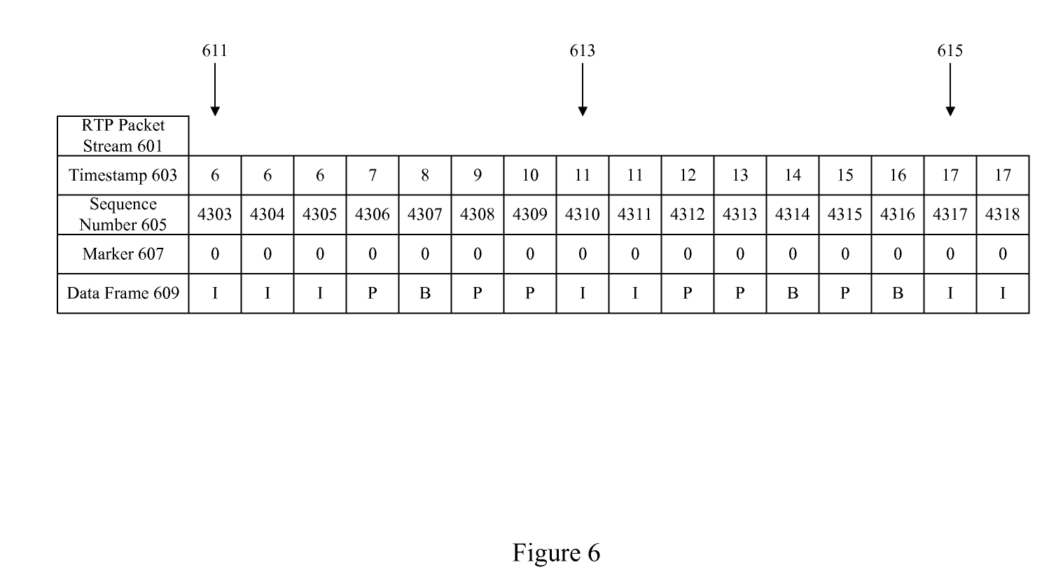

FIG. 6 illustrates various starting points at which a media stream can resume in an RTP packet stream. An RTP packet stream 601 includes individual packets having a variety of fields and payload data. According to various embodiments, the fields include a timestamp 603, sequence 605, marker 607, etc. The packets also include payload data 609 holding MPEG frames such as I, P, and B-frames. Timestamps for different packets may be the same. In particular examples, several packets carrying portions of the same I-frame have the same time stamp. However, sequence numbers are different for each packet. Marker bits 607 can be used for different purposes, such as signaling the starting point of an advertisement.

According to various embodiments, packets with sequence numbers 4303, 4304, and 4305 carrying potions of the same I-frame and have the same timestamp of 6. Packets with sequence numbers 4306, 4307, 4308, and 4309 carry P, B, P, and P-frames and have timestamps of 7, 8, 9, and 10 respectively. Packets with sequence numbers 4310 and 4311 carry different portions of the same I-frame and both have the same timestamp of 11. Packets with sequence numbers 4312, 4313, 4314, 4315, and 4316 carry P, P, B, P, and B-frames respectively and have timestamps 12, 13, 14, 15, and 16. It should be noted that the timestamps shown in FIG. 6 are merely representational. Actual timestamps can be computed using a variety of mechanisms.

According to various embodiments, positions 611, 613, and 615 indicate points at which a media stream may be resumed. In particular embodiments, a media stream resumes at an I-frame to provide a device with enough information to generate a complete picture immediately, instead of providing a P-frame or a B-frame with only differential information insufficient to generate a complete picture. Positions 611, 613, and 615 or corresponding timestamps 6, 11, and 17 may be associated with a user device and maintained at a content server. According to various embodiments, possible starting positions may include times many hours or many days in the past, depending on the amount of buffer space at a content server.

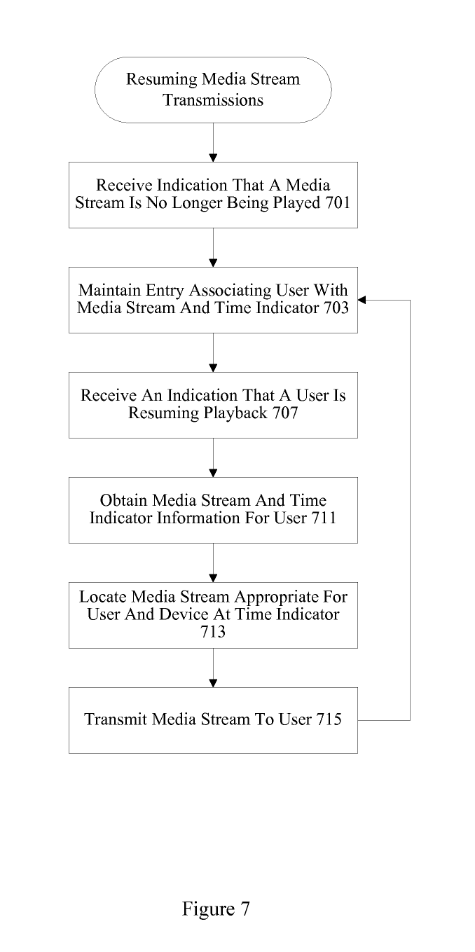

FIG. 7 illustrates one technique for resuming media stream transmissions. In many conventional implementations, when a media stream session is broken for any reason, the user must reestablish the session and the media stream transmissions resume at a current point in time. In some examples, a user may miss important content simply by switching devices or losing wireless reception. Consequently, the techniques of the present invention allow a user to resume a media stream where the stream was stopped. In some examples, a user can elect whether to play a stream as a live stream or play a stream where the stream was stopped. In still other examples, a user can elect a specific time to view a stream.

According to various embodiments, an indication that a media stream is no longer being played is received at 701. In particular embodiments, the indication is a session break message. In other embodiments, the indication a specialized command or some other termination of service. At 703, an entry is maintained associating the user with the media stream being viewed and a time indicator. According to various embodiments, a device identifier is maintained instead of a user identifier. Channels and quality levels may also be optionally maintained. At 707, an indication is received that a user is resuming playback. At 711, the media stream identifier and time indicator information for the user is obtained. At 713, the media stream appropriate for the user and device is located at the particular time indicator. According to various embodiments, a high bandwidth media stream is obtained if the user is viewing the media stream using large screen device connected to a high speed network. In particular embodiments, a low bandwidth media stream is obtained if the user is viewing the media stream using a small screen device connected to a bandwidth limited network. At 715, the media stream is transmitted to the user.

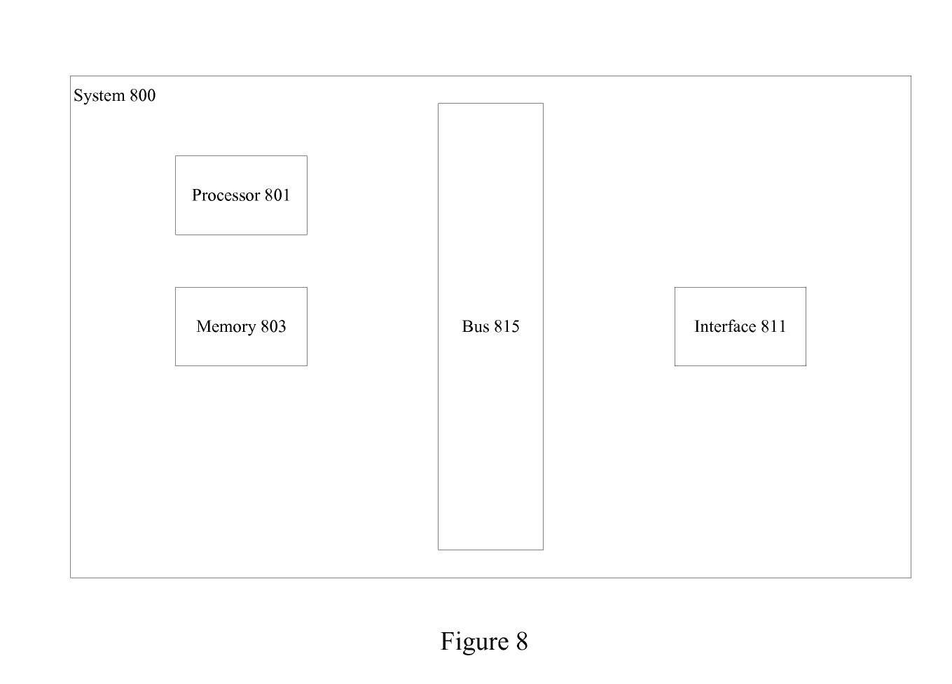

FIG. 8 illustrates one example of a content server. According to particular embodiments, a system 800 suitable for implementing particular embodiments of the present invention includes a processor 801, a memory 803, an interface 811, and a bus 815 (e.g., a PCI bus or other interconnection fabric) and operates as a streaming server. When acting under the control of appropriate software or firmware, the processor 801 is responsible for modifying and transmitting live media data to a client. Various specially configured devices can also be used in place of a processor 801 or in addition to processor 801. The interface 811 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 800 is a content server that also includes a transceiver, streaming buffers, and a program guide database. The content server may also be associated with subscription management, logging and report generation, and monitoring capabilities. In particular embodiments, functionality for allowing operation with mobile devices such as cellular phones operating in a particular cellular network and providing subscription management. According to various embodiments, an authentication module verifies the identity of devices including mobile devices. A logging and report generation module tracks mobile device requests and associated responses. A monitor system allows an administrator to view usage patterns and system availability. According to various embodiments, the content server 891 handles requests and responses for media content related transactions while a separate streaming server provides the actual media streams.

Although a particular content server 891 is described, it should be recognized that a variety of alternative configurations are possible. For example, some modules such as a report and logging module 853 and a monitor 851 may not be needed on every server. Alternatively, the modules may be implemented on another device connected to the server. In another example, the server 891 may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method, comprising:
maintaining information associating a user with a plurality of devices and subscription information;
receiving a first request for the media stream from the user on a first device;
verifying that the user is authorized to receive the media stream on the first device based on subscription information;
transmitting the media stream to the first device;
receiving a playback end signal from the user on the first device;
storing information associating a user with a media stream and time information, the content server operable to provide a plurality of live media streams corresponding to the subscription information to the user;
receiving a second request for the media stream from the user on a second device;
transmitting the media stream to the user on the second device beginning with packets selected using the time information maintained at the content server.

2. The method of claim 1, wherein the second request is a command to resume playback.

3. The method of claim 1, wherein the first request is a command to establish a session.

4. The method of claim 1, wherein information at the content server is stored after an indication that the media stream is no longer being played is received.

5. The method of claim 4, wherein the media stream is no longer being played when a session is stopped.

6. The method of claim 1, wherein the user requests the media stream from a mobile device.

7. The method of claim 1, wherein characteristics of the first device and characteristics of the second device are different.

8. The method of claim 1, wherein the device uses the timing information and sequence number information to decode the media stream for playback.

9. The method of claim 1, wherein the device receives the plurality of packets in order based on sequence number information.

10. The method of claim 1, wherein the plurality of live media streams are buffered in a plurality of channel buffers.

11. The method of claim 1, wherein the live media stream is a Real-Time Transport Protocol (RTP) stream.

12. The method of claim 1, wherein the content server is connected over a network to a controller operable to establish a session with the device using a Real-Time Streaming Protocol (RTSP).

13. The method of claim 1, wherein the live media stream comprises a plurality of packets holding I-frames, P-frames, and B-frames.

14. The method of claim 1, wherein the content server resumes transmission by identifying a selecting an I-frame.
